(19) United States
(12) Patent Application Publication
(10) Pub. No.: US 2007/0035133 A1
(43) Pub. Date: Feb. 15, 2007

(54) Enhanced engine for improving output torque and power distribution system for providing power to the engine

(76) Inventor: Komad Parsa, Laguna Niguel, CA (US)

Correspondence Address: Brian M. Berliner;O'MELVENY & MYERS LLP, 400 South Hope Street, Los Angeles, CA, 90071-2899, US

(21) Appl. No.: 11/492,511

(22) Filed: Jul. 24, 2006

Related U.S. Application Data
(60) Provisional application No. 60/703,729, filed on Jul. 29, 2005.

(51) Int. Cl. H02K 7/18

(52) U.S. Cl. 290/1 R

(57) ABSTRACT

An enhanced engine for improving output torque and a power distribution system for feeding power to the engine. In an embodiment, the engine comprises a central shaft, a plurality of armatures, and a plurality of motors. The central shaft is adapted to rotate about an axis. The armatures are coupled to the central shaft and extend radially therefrom. The motors are coupled to respective armatures, each of the motors having a respective shaft and a propeller affixed to an end of each respective shaft. Each propeller is driven to rotation by operation of the respective motor. The rotating propellers drive air movement, thereby providing a torque that causes the central shaft to rotate with a tangential force corresponding to the weight of the rotating mass multiplied by the length of the armatures providing a flywheel effect that yields horsepower greater than the sum of the horsepower of each motor.

### CROSS-REFERENCE TO RELATED APPLICATION

This application claims priority pursuant to 35 U.S.C. § 119(e) to U.S. Provisional Application No. 60/703,729, filed Jul. 29, 2005, which application is specifically incorporated herein, in its entirety, by reference.

### BACKGROUND OF THE INVENTION

1. Field of the Invention

The present invention relates to an enhanced engine for improving output torque and a power distribution system for providing power to the engine.

2. Description of Related Art

Various motors and engines are known in the art for numerous applications, including transportation, industrial, and consumer uses. Engine manufacturers are faced with major challenges in their quest to build better engines or motors. Some challenges include achieving higher power per unit engine mass. Higher horsepower output is desired without changing the weight of the engine producing improved engine efficiency. Reduction of emissions and pollution is also a challenge due to the environmental impact of engine emissions. Manufacturers are challenged to produce engines with improved reliability to reduce repair costs to the consumer and improve customer satisfaction in order to garner manufacturer loyalty. Manufacturers are also challenged to select a fuel supply that is readily available. Alternative fuels (e.g., batteries or hydrogen cells) may provide advantages but are negated if the supply is not readily accessible for mass manufacturing.

Electrical motors have no emissions, high efficiency and very good reliability, but their weight, including that of the batteries, is a major drawback. For example, battery weight becomes a limiting factor in the adoption of electric motors for transportation applications, as desired driving ranges cannot be achieved without excessive battery weight.

An electric motor operates by turning a coil within an electromagnetic field. The radius of the coil is relatively small and an armature generally runs through the center of the coil. The electromotive force may be exerted a short distance from the center of rotation for the coil, providing little leverage. As an example, turning a bolt with a very short spanner is much more difficult than with a long handled spanner. The radius of the turning lever has a direct relationship to the ease at which the lever can be turned. As electric motors have relatively small armatures, a gearbox is usually used to increase the output torque, which, in turn, increases the effective engine mass and lowers efficiency.

Power to a rotating shaft requires special power connections as wires will get tangled on the rotating shaft if a wired connection is used. Current systems use either a brush and commutator connection or a brushless motor connection. Power supplied by a brush and commutator apply power by connecting a battery or AC power to carbon or copper brushes that make contact with a commutator or slip ring. The brushes conduct current between stationary power wires and the rotor. Many of the limitations of the classic motor are due to the need for brushes to press against the commutator or slip ring, creating friction. At higher speeds, brushes have increasing difficulty in maintaining contact. Brushes may bounce off the irregularities in the commutator or slip ring surface, creating sparks and limiting the maximum speed of the machine. The output of the system is, likewise, limited by the current density per unit area of the brushes. The imperfect electric contact also causes electrical noise. Brushes eventually wear out and require replacement.

Current systems using brushless power distribution comprise an intelligent electronic controller. The controller performs the same power distribution found in a brushed system, only without using a commutator and brush assembly. The controller comprises a bank of high-power metal oxide semiconductor field-effect transistor (MOSFET) devices to drive power, and a microcontroller to precisely orchestrate the rapid-changing current-timings required. Because the controller must follow the rotor, the controller needs some way of determining the rotor's orientation relative to the stator. Sensors are often used for determining the rotor orientation. The main disadvantage of current brushless systems is the higher cost, which arises from the requirement for high-power MOSFET devices in the fabrication of the electronic speed controller.

It is desired, therefore, to improve torque output from an engine as well as supply power to the rotor without sacrificing efficiency or cost.

### SUMMARY OF THE INVENTION

The present invention addresses the shortcomings of the prior art systems and methods. In particular, the present invention is directed to an engine that uses leverage to create more torque, and more horsepower per unit weight, in order to improve effectiveness. By combining electric motors into a framework, increased torque can be achieved by creating leverage with respect to an output shaft. The benefit is that the increased torque through leverage means that smaller motors can be used to drive the same load as a larger single electric motor. Advantageously, smaller motors require less power. Additionally, power is supplied to the rotating output shaft through a conductive ball bearing assembly. The rotating shaft comprises two electrically isolated shaft portions. The electrical contacts of the motors are connected to the two shaft portions, which are each connected to one of two power contacts through the ball bearing assembly, thereby increasing efficiency and reducing cost over traditional brush and commutator and brushless motor power connections.

In accordance with one aspect of the embodiments described herein, an engine comprises a central shaft, a plurality of armatures, and a plurality of motors. The central shaft is adapted to rotate about an axis. The plurality of armatures are coupled to the central shaft and extend radially therefrom. The plurality of motors are coupled to respective ones of the plurality of armatures, each of the plurality of motors having a respective shaft and a propeller affixed to an end of each respective shaft, and each propeller being driven to rotation by operation of the respective one of the plurality of motors. The rotating propellers drive air movement providing a torque that causes the central shaft to rotate with a tangential force corresponding to the weight of the rotating mass multiplied by the length of the armatures. This provides a flywheel effect that yields horsepower that is greater than the sum of the horsepower of each one of the plurality of motors.

In another embodiment of the invention, the central shaft of the engine described above comprises a first central shaft portion and a second central shaft portion. The second central shaft portion is electrically insulated from and rigidly affixed to the first central shaft portion. The first central shaft portion is attached to a first conductive rolling-element rotary bearing and the second central shaft portion is attached to a second conductive rolling-element rotary bearing. The engine further comprises a power source connected to the first conductive rolling-element rotary bearing and the second conductive rolling-element rotary bearing. The power source comprises a first lead and a second lead. The first lead is connected to the first conductive rolling-element rotary bearing and the second lead is connected to the second conductive rolling-element rotary bearing. Power is supplied to each of the plurality of motors via a first connection to the first central shaft portion and a second connection to the second central shaft portion. Each of the plurality of motors are electrically insulated from the central shaft. The power connection described above provides more efficient rotation than brush/commutator distributions systems and provides a lower cost than conventional brushless distribution systems.

A more complete understanding of the engine and power distribution system for providing power to the engine will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a top view showing an apparatus according to an embodiment of the invention;

FIG. 2 is a simplified plan view showing an apparatus of the type shown in FIG. 1;

FIG. 3 is a cross-sectional view of an apparatus of the type shown in FIG. 1, showing details of the mounting system and power distribution, for a system using a single main shaft bearing;

FIG. 4 is a cross-sectional view of an apparatus of the type shown in FIG. 1, showing details of the mounting system and power distribution, for a system using dual main shaft bearings;

FIG. 5 is a plan view showing a gear-driven apparatus according to an alternative embodiment of the invention;

FIG. 6 is a cross-sectional view showing a gear-driven apparatus according to an alternative embodiment of the invention;

FIG. 7 is a cross-sectional view of an apparatus according to an alternative embodiment of the invention, showing details of the mounting system and power distribution;

FIG. 8 is a sectional view of an apparatus of the type shown in FIG. 7, showing details of the mounting system and power distribution; and

FIG. 9 is a side view of an apparatus according to an alternative embodiment of the invention and of the type shown in FIG. 7.

### DETAILED DESCRIPTION OF THE PREFERRED EMBODIMENT

The present invention provides an enhanced engine for improving output torque without sacrificing efficiency. By combining electric motors into a framework, increased torque can be achieved by using leverage with respect to an output shaft to create more torque, thereby generating more horsepower per unit weight. Additionally, power is supplied to the output shaft through a conductive ball bearing assembly. The electrical contacts of the motors are connected to the output shaft. The output shaft comprises two electrically isolated shaft portions that are each connected to one of two power contacts through the ball bearing assembly, thereby increasing efficiency and reducing cost over traditional brush/commutator and brushless motor power connections. In the detailed description that follows, like element numerals are used to describe like elements appearing in one or more of the figures.

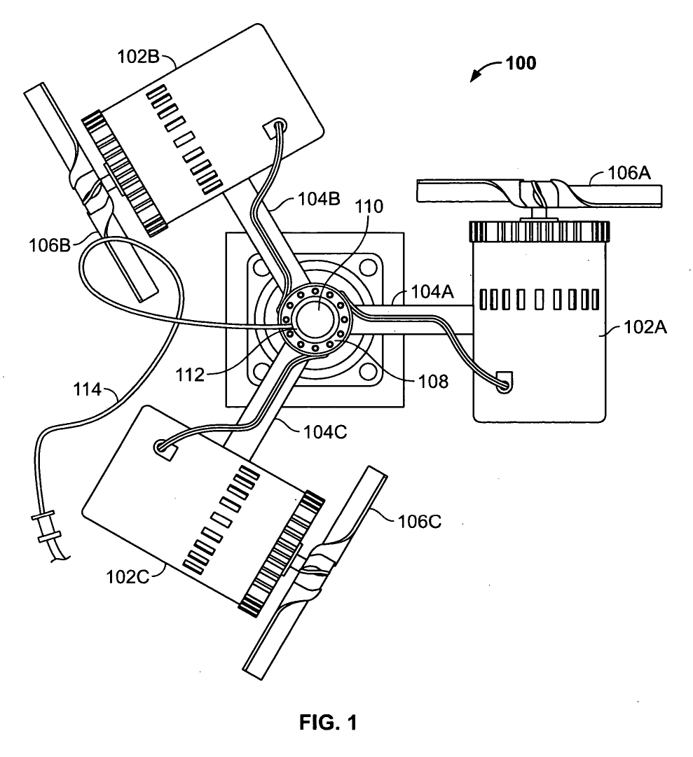

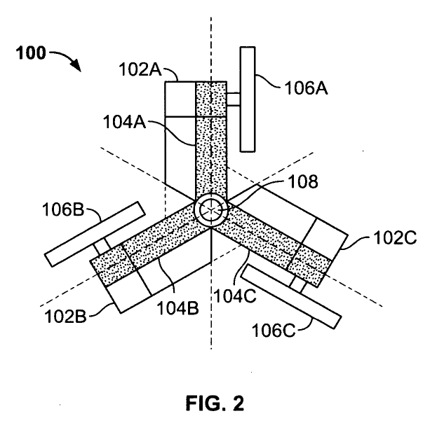

FIGS. 1 and 2 show an engine 100 according to an embodiment of the invention. Engine 100 comprises three electric motors 102A-C attached to respective armatures 104A-C extending radially from a main shaft 108. It should be appreciated that the armatures 104A-C may vary in length and the mounting angle of the motors 102A-C with respect to the armatures 102A-C may vary from the perpendicular arrangement shown. The motors 102A-C are arranged radially around the main shaft such that the weight of the motors is balanced. Thus, the motors 102A-C will not move due to gravity. The motors 102A-C will remain stationary until an external force is applied to the rotating portion of the engine, which comprises the combination of motors 102A-C, armatures 104A-C, and main shaft 108 or until the motors 102A-C exert a motive force at or near the end of the armatures 104A-C using propellers 106A-C. It should be further appreciated that the propellers 106A-C may vary from those shown to provide different combinations of weight and thrust. The thrust derived from the motive force of the propellers 106A-C reduces the negative effects of the dead load and creates more torque than would normally be generated from the summation of the three individual motors 102A-C.

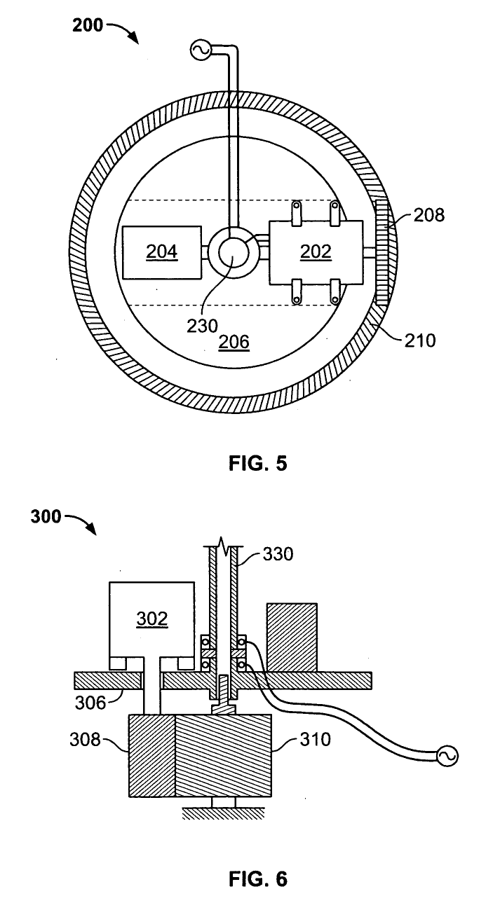

A power shaft 110 supplies the electric motors with electricity through a conductive bearing 112. Power may be supplied through a cord 114. In the illustrated embodiment, the electric motors are installed in a star shaped configuration and the motion of the main shaft 108 around its axis results from forced air via the propeller 106A-C function. It should be appreciated that other motive mechanisms, such as a gear mechanism described in further detail and shown in FIGS. 5-6, may also be used.

There are different ways to calculate the power of the system 100, for example one could calculate the kinetic energy of the system and convert kinetic energy to horsepower. Or, alternatively, one could calculate the torque and then derive the horsepower, which is the method used here.

Torque is defined as the force at any one point on the edge of a circle in the exact direction of the rotation multiplied by the radius. In the metric system, force is calculated in Newtons, and distance in meters so the torque unit is Newton-meters. In the standard system, which will be used here, force is calculated in pounds and distance in feet providing a torque unit of foot-pounds.

For rotational movement:
Torque=force*distance=weight*r

Where:

r (ft)=radius of the rotor armature

weight (lbs)=engine and armature weight
Horsepower=(Torque/5,252)*RPM

Where RPM=revolutions per minute of the main shaft

Therefore: Horsepower=((weight*r)/5,252)*RPM

Each of the three electric motors used in an exemplary embodiment of the invention generates ⅓ horsepower (0.33 hp). The total power of the three motors should therefore be 3*0.33=0.99 hp.

For the exemplary embodiment, the three electrical motors are each installed 1 foot from the main shaft. The total apparatus structure weighs 65.7 pounds. The motors each weigh 14.9 pounds and the mounting brackets each weigh 7 pounds. The exemplary embodiment torque is therefore:
Torque=weight*r=65.7*1=65.7 ft-lbs
With the RPM generated by the motors at 240, the calculation becomes:
Horsepower=(Torque/5,252)*RPM=(65.7/5252)*240=3.002 hp
The horsepower increase is a factor of 3 when comparing the horsepower generated for the exemplary embodiment (3.002) to the sum of the horsepower of the individual motors used (0.99). It should be appreciated that horsepower is directly related to the RPM, therefore a lighter shaft construction may utilize the distributed power more efficiently, thus generating higher RPM and producing exponentially greater horsepower from the present invention.

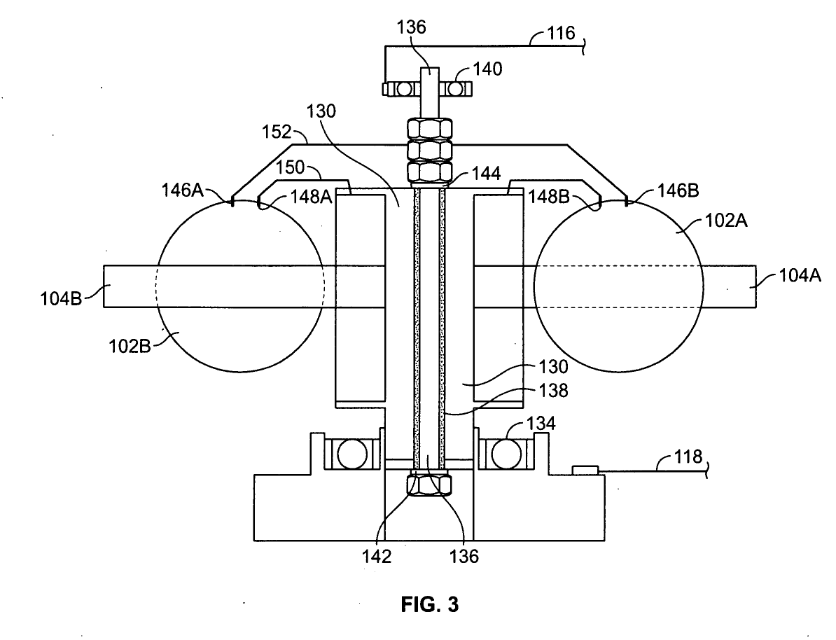

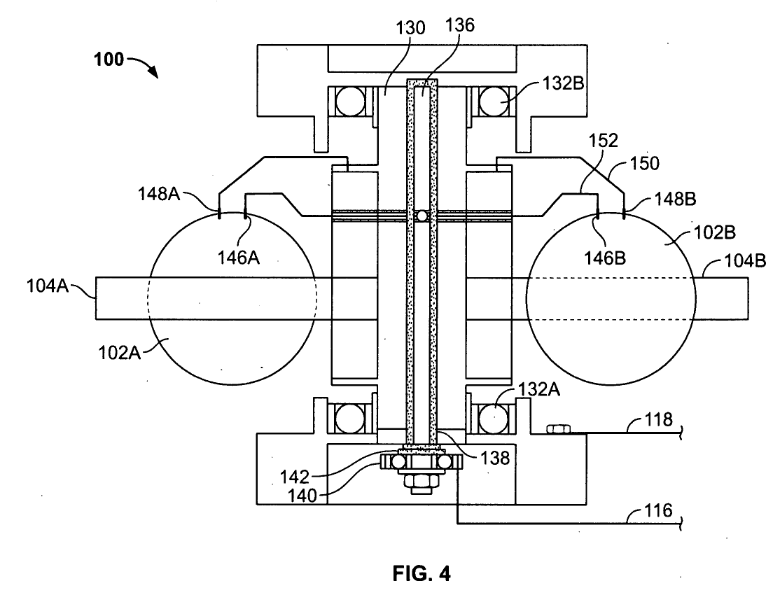

Referring to the embodiments of the invention shown in FIGS. 3 and 4, an engine 100 is supported by a main shaft 130. The main shaft 130 is equivalent to a rotor for this engine. FIG. 4 shows a main shaft 130 supported by ball bearings 132A-B at opposite ends. FIG. 3 shows a main shaft 130 supported by a single ball bearing 134 at a lower end, which may be more suitable for small-scale operations.

FIGS. 3 and 4 also show a center shaft 136, an electrically insulating sleeve 138, a main shaft 130, armatures 104A-B, motors 102A-B, and two sets of ball bearings (main ball bearing 134 or 132A-B and central shaft ball bearing 140). The central shaft 136 is rigidly affixed to main shaft 130 with an insulating sleeve 138 positioned between to provide electrical insulation. The main shaft 130 encloses the center shaft and the insulating sleeve 138 and all move together when rotating about their axis.

The armatures 104A-B are attached to the main shaft 130 and each armature is attached to a respective electrical motor 102A-B. A third motor and corresponding structures are not shown in FIGS. 3-4 as they are located behind the structure in the field of vision of the drawing. It should be appreciated that any number of motors and armatures may be used. Armatures 104A-B may be replaced by a disk, frame, or any other suitable structure for holding the motors 102A-B in a desired orientation relative to the rotating shafts.

The central shaft 136 is attached to electrical terminals 146A-B. These terminals are electrically insulated, by the insulating sleeve 138 and the insulating washers 142, 144, from the electrical contacts 148A-B that are attached to the main shaft 130. The central shaft 136 is connected to ball bearing 140, which, in turn, is connected to power line 116. The main shaft 130 is connected to ball bearing 134, 132A, which, in turn, is connected to power line 118. Thus, one power supply line 118 is connected to the body of the main shaft 130 through the main shaft ball bearings 134, 132A that act as connectors. The other line 116 is connected to the center shaft 136 distributing power through the center shaft ball bearing 140.

Wire 152 connects power between electrical contacts 146A-B and the center shaft 136. Likewise, wire 150 connects power between electrical contacts 148A-B and the main shaft 130. The electrical contacts 146A-B, 148A-B connect to the respective motors 102A-B and create a complete electrical circuit. Electricity is distributed continuously to the motors 102A-B while they are in motion as a result of the shaft design, which acts as an electrical circuit.

In a battery powered application, a system battery may also be incorporated into or attached to the rotating shafts. A rotating battery advantageously increases the rotating mass to achieve an enhanced flywheel effect. The battery may be connected to a stationary (i.e., non-rotating) electrical system for associated equipment, such as in a motor vehicle, using electrical connectors as herein described.

FIG. 5 shows an alternative embodiment in which a system 200 comprises a single motor 202 and counterweight 204 mounted to a disk-like rotating support 206. A support system as previously described may be used to support and provide power to the motor 202. An output shaft of motor 202 may rotate a suitable gear, e.g., a spur gear 208 or helical gear, which is meshed with a ring gear 210 around an outer periphery of disk support 206. Hence, motor 202 drives disk 206 via gears 208, 210. A central output shaft or main shaft 230 is connected to the center of rotation of disk 206 and may be used for any suitable purpose.

FIG. 6 shows another alternative embodiment 300 in which motor 302 is mounted with an output shaft perpendicular to support 306. A pair of helical gears 308, 310 may be used to provide traction for the motor around output shaft 330. Other details may be as previously described. FIGS. 5 and 6 illustrate that various different motor and drive configurations may be adapted for use as alternate embodiments of the invention.

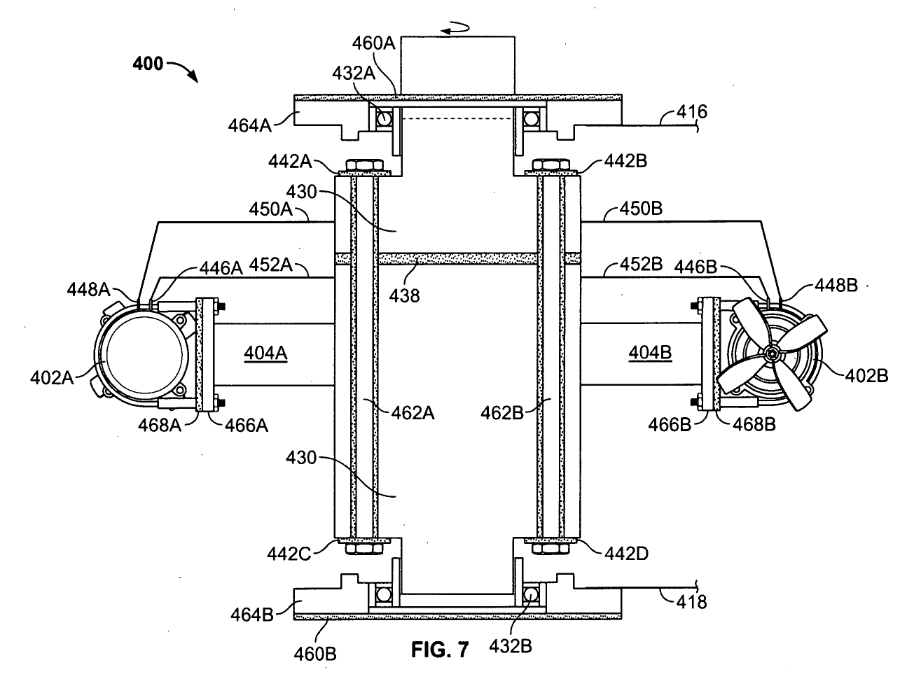

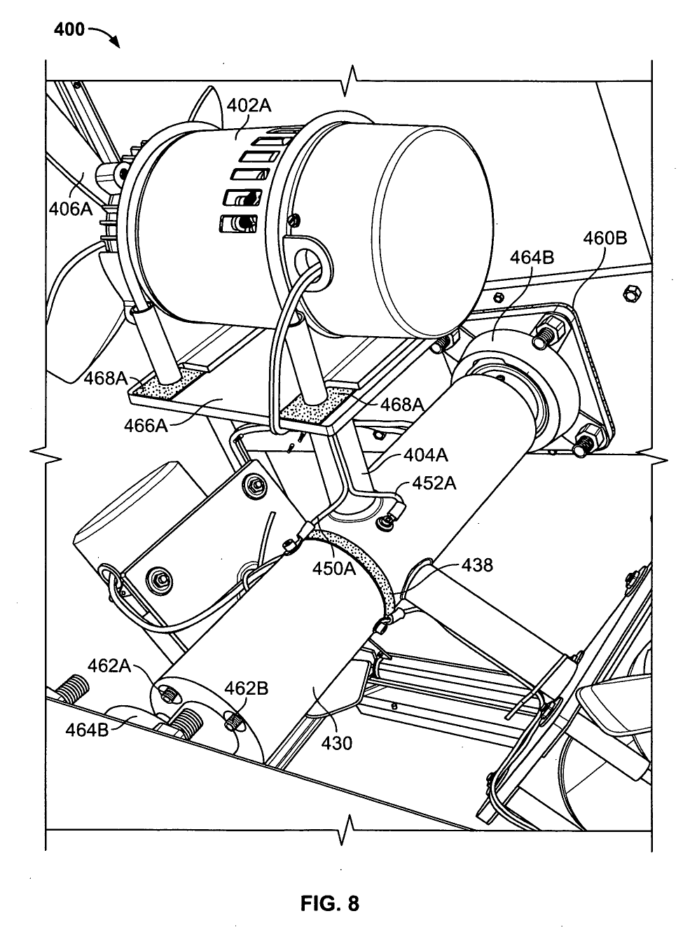

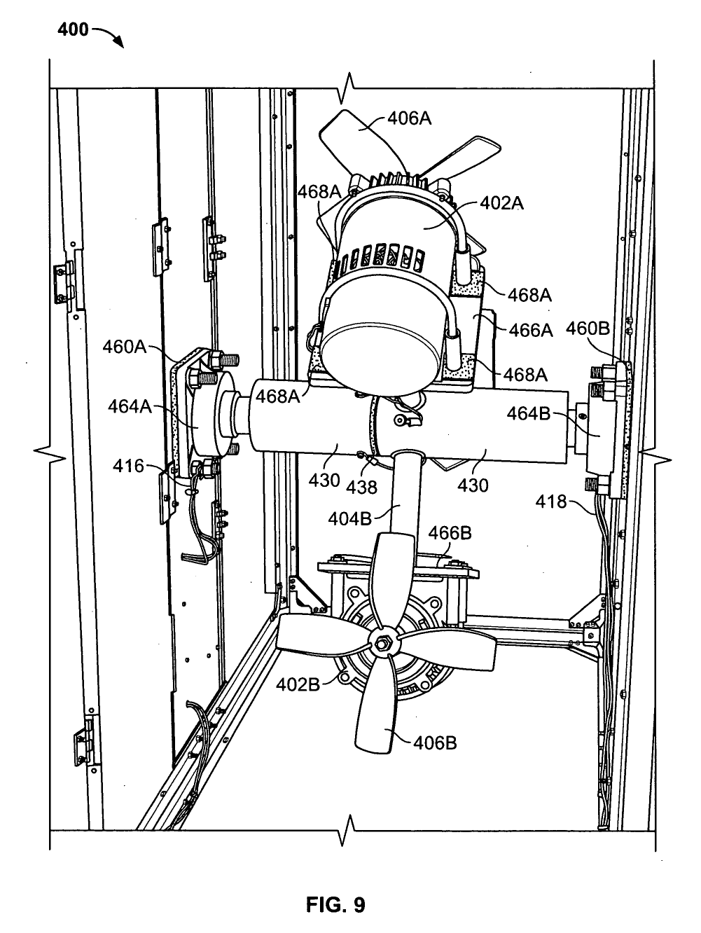

FIGS. 7-9 show an alternative embodiment of the enhanced engine comprising an alternative electrical connection to the engine 400. The present embodiment comprises the following main components: a main shaft 430; two sets of ball bearings 432A-B contained in ball bearing housings 464A-B, respectively; armatures 404A-B; and motors 402A-B. The main shaft 430 operates similar to a rotor for the engine. At each end of the main shaft 430, there is a ball bearing 432A-B contained within a ball bearing housing 464A-B that is attached to a pair of electrical terminals. The main shaft 430 is formed from two parts that are electrically insulated 438 from each other and are fastened together, via four electrically insulated sleeved bolts (only two are shown) 462A-B, to form one rotating unit. The electrically insulated sleeved bolts 462A-B are additionally insulated at each end by insulation washers 442A-D. The first main shaft part is attached with wires 450A-B to electrical terminals 448A-B on motors 402A-B, respectively. Similarly, the second main shaft part is attached with wires 452A-B to electrical terminals 446A-B on motors 402A-B, respectively. The electrical insulation 438 insulates the first main shaft part terminals 448A-B from the second main shaft part terminals 446A-B.

The first main shaft part is connected to conductive ball bearing 432A, which is contained in ball bearing housing 464A. The ball bearing housing 464A is connected to power line 416. The second main shaft part is connected to conductive ball bearing 432B, which is contained in ball bearing housing 464B. Ball bearing housing 464B is connected to power line 418. Thus, one power supply line 418 is connected to the body of the main shaft 430 through the conductive ball bearing 432B that acts as a connector. The other power line 416 is connected to the other side of the main shaft 430 distributing power through the conductive ball bearing 432A. Electrical insulation 460A-B is affixed between each ball bearing housing 464A-B and the containment unit to isolate the power to the ball bearing housing 464A-B and main shaft 430 assembly.

Each motor 402A-B is fastened to a mounting plate 466A-B that is connected to the main shaft 430 via armatures 404A-B, respectively. It should be appreciated that although the mounting plate 466A-B is shown parallel to the main shaft 430 assembly, it may instead be oriented at an angle. Each motor 402A-B comprises a respective shaft that rotates when power is applied to the motor. A propeller 406A-B is affixed to the respective shaft to provide tangential thrust and drives the rotation of the rotation portion of the engine which comprises the combination of motors 402A-B, armatures 404A-B, and main shaft 420. Insulating material 468A-B is used to electrically isolate the motor from the powered main shaft 430, armature 404A-B, and mounting plate 466A-B assembly. Electrical contacts 446A-B, 448A-B connect power to the motors 402A-B at the end of each armature 404A-B through wires 450A-B, 452A-B that connect to the main shaft 430 to create a complete electrical circuit. Electricity is distributed continuously to the motors 402A-B while they are in motion as a result of the shaft design, which acts as an electrical circuit.

In an embodiment of the invention, an entire electric motor 402A, including rotor, stator, and housing, is mounted on a rotating wheel or other rotor. A battery may also be mounted on the wheel. Preferably, the motor is mounted near an outer circumference of the wheel. One or more additional motors 402B-C may similarly be mounted on the wheel, so as to maintain the wheel in a balanced configuration. In the alternative, or in addition, weights may be used to balance the wheel. The wheel is connected to and drives a central output shaft 430, and is supported by one or more bearings 432A-B, for example ball bearings. Electric power is supplied to the motor or motors through a pair of rotating contacts or through the conductive ball bearings 432A-B. Each motor has an output shaft connected to a device for applying a tangential rotational force to the wheel. For example, the motor shaft may drive a spur gear that meshes with a ring gear around the circumference of the wheel. For further example, the motor may drive a propeller 406A-C to provide tangential thrust. The motor therefore drives the wheel so as to rotate around its output shaft 430. The benefit of the present invention is that force is applied at an increased lever armature relative to the output shaft 430, resulting in higher output torque. A further benefit is that the entire weight of the electric motor 402A is used to add mass and momentum to the rotating wheel, resulting in a beneficial flywheel effect at a lower total engine weight. Rotation of the motor also provides a beneficial cooling effect for the electric motor 402A derived from the airflow produced the rotation of the system.

Having thus described a preferred embodiment of an apparatus for enhancing performance of an engine and an apparatus for distributing power in a rotating device, it should be apparent to those skilled in the art that certain advantages of the described system have been achieved. It should also be appreciated that various modifications, adaptations, and alternative embodiments thereof may be made within the scope and spirit of the present invention. For example, an electric motor has been illustrated, but it should be apparent that the inventive concepts described above would be equally applicable to other types of motors such as pneumatic or hydraulic motors. The number and size of the engines would be related to the application.

The invention is solely defined by the following claims.

What is claimed is:

1. An engine comprising:
a central shaft adapted to rotate about an axis;
a plurality of armatures coupled to the central shaft and extending radially therefrom; and
a plurality of motors coupled to respective ones of the plurality of armatures, each of the plurality of motors having a respective shaft and a propeller affixed to an end of each respective shaft, each propeller being driven to rotation by operation of the respective one of the plurality of motors;
wherein, the rotating propellers drive air movement providing a torque that causes the central shaft to rotate with a tangential force corresponding to the weight of the rotating mass multiplied by the length of the armatures, thereby providing a flywheel effect that yields horsepower that is greater than the sum of the horsepower of each one of the plurality of motors.

2. The engine of claim 1, wherein the respective shafts of the plurality of motors are oriented between 45 degrees and 135 degrees from the central shaft.

3. The engine of claim 2, wherein the respective shafts of the plurality of motors are oriented perpendicular to the central shaft.

4. The engine of claim 1, wherein the plurality of armatures extend radially such that the plurality of motors are in a balanced configuration around the central shaft.

5. The engine of claim 1, further comprising a battery affixed to the rotating motors, armatures, and the central shaft of the engine to supply power to the plurality of motors.

6. The engine of claim 1, wherein each of the plurality of motors is coupled to an end of a respective one of the plurality of armatures.

7. The engine of claim 1, wherein each of the plurality of motors is coupled to a side of a respective one of the plurality of armatures.

8. The engine of claim 1, wherein the central shaft comprises a first central shaft portion and a second central shaft portion, the second central shaft portion being electrically insulated from and rigidly affixed to the first central shaft portion.

9. The engine of claim 8, wherein the first central shaft portion is rigidly affixed to the second central shaft portion via a plurality of electrically insulated sleeved bolts.

10. The engine of claim 8, wherein the first central shaft portion is attached to a first conductive rolling-element rotary bearing and the second central shaft portion is attached to a second conductive rolling-element rotary bearing.

11. The engine of claim 10, further comprising a power source connected to the first conductive rolling-element rotary bearing and the second conductive rolling-element rotary bearing.

12. The engine of claim 11, wherein the power source comprises a first lead and a second lead, the first lead being connected to the first conductive rolling-element rotary bearing and the second lead being connected to the second conductive rolling-element rotary bearing.

13. The engine of claim 12, wherein power is supplied to each of the plurality of motors via a first connection to the first central shaft portion and a second connection to the second central shaft portion.

14. The engine of claim 13, wherein each of the plurality of motors are electrically insulated from the central shaft.

15. The engine of claim 14, wherein the first central shaft portion comprises an inner shaft and the second shaft portion comprises an outer shaft, the outer shaft being concentrically arranged around the inner shaft.

16. The engine of claim 14, wherein the electrical insulation between the first central shaft portion and the second central shaft portion is oriented perpendicular to the axis of rotation of the central shaft.

17. The engine of claim 14, wherein the power source comprises an AC power source.

18. The engine of claim 14, wherein the power source comprises a DC power source.

19. The engine of claim 18, wherein the power source comprises a battery.

20. An engine comprising:
a central shaft adapted to rotate about an axis, the central shaft having a first portion and a second portion, the first and second portions being electrically insulated from each other;
a plurality of armatures coupled to the central shaft and extending radially therefrom;
a plurality of motors coupled to respective ones of the plurality of armatures, each of the plurality of motors having a respective shaft and a propeller affixed to an end of each respective shaft, each propeller being driven to rotation by operation of the respective one of the plurality of motors; and
a power source operatively coupled to the plurality of motors through the central shaft and plurality of armatures, the power source having a first terminal operatively coupled to the first portion of the central shaft and a second terminal operatively coupled to the second portion of the central shaft;
wherein, the rotating propellers drive air movement providing a torque that causes the central shaft to rotate with a tangential force corresponding to the weight of the rotating mass multiplied by the length of the armatures, thereby providing a flywheel effect that yields horsepower that is greater than the sum of the horsepower of each one of the plurality of motors.

21. The engine of claim 20, wherein the respective shafts of the plurality of motors are oriented between 45 degrees and 135 degrees from the central shaft.

22. The engine of claim 21, wherein the respective shafts of the plurality of motors are oriented perpendicular to the central shaft.

23. The engine of claim 20, wherein the plurality of armatures extend radially such that the plurality of motors are in a balanced configuration around the central shaft.

24. The engine of claim 20, wherein each of the plurality of motors is coupled to an end of a respective one of the plurality of armatures.

25. The engine of claim 20, wherein each of the plurality of motors is coupled to a side of a respective one of the plurality of armatures.

26. The engine of claim 20, wherein first portion of the central shaft is rigidly affixed to the second portion of the central shaft.

27. The engine of claim 26, wherein the first portion of the central shaft is rigidly affixed to the second portion of the central shaft via a plurality of electrically insulated sleeved bolts.

28. The engine of claim 20, wherein the first terminal is operatively coupled to the first portion of the central shaft via a first conductive rolling-element rotary bearing and the second terminal is operatively coupled to the second portion of the central shaft via a second conductive rolling-element rotary bearing.

29. The engine of claim 28, wherein the first conductive rolling-element rotary bearing and the second conductive rolling-element rotary bearing are ball bearings.

30. The engine of claim 20, wherein each of the plurality of motors are electrically insulated from the central shaft.

31. The engine of claim 20, wherein the first portion of the central shaft comprises an inner shaft and the second portion of the central shaft comprises an outer shaft, the outer shaft being concentrically arranged around the inner shaft.

32. The engine of claim 20, wherein the electrical insulation between the first portion of the central shaft and the second portion of the central shaft is oriented perpendicular to the axis of rotation of the central shaft.

33. The engine of claim 20, wherein the power source comprises an AC power source.

34. The engine of claim 20, wherein the power source comprises a DC power source.

35. The engine of claim 34, wherein the power source comprises a battery.

36. The engine of claim 35, wherein the battery is affixed to the rotating motors, armatures, and the central shaft of the engine.
